(19) United States
(12) Patent Application Publication
(10) Pub. No.: US 2025/0135852 A1
(43) Pub. Date: May 1, 2025

(54) SOLAR CAR COVER FOR A PICKUP TRUCK

(71) Applicant: ZHEJIANG SURPASS AUTO PARTS CO., LTD., WENZHOU (CN)

(72) Inventor: Yi LIN, WENZHOU (CN)

(21) Appl. No.: 19/010,138

(22) Filed: Jan. 5, 2025

Related U.S. Application Data
(63) Continuation of application No. 17/950,269, filed on Sep. 22, 2022, now Pat. No. 12,251,997.

(51) Int. Cl. B60J 7/14; F16C 11/04

(52) U.S. Cl. CPC B60J 7/141; F16C 11/04

(57) ABSTRACT

The present application discloses a solar car cover for a pickup truck. At least two first support rods are arranged in the direction of the first frame and are connected to the two first frames. The first support rods are either bonded or abutted to the panel. At least one second support rod is provided along the vertical direction of the second frame, with at least one end of the second support rod connected to the second frame. The second support rod is either bonded or abutted to the panel. The first support rods and the second support rods can be bonded, abutted, or connected through fasteners. The embodiment of the invention provides a solar car cover for a pickup truck, which uses the first and second support rods to cross-support and fix the solar panels in multiple directions and positions.

### CROSS-REFERENCES TO RELATED APPLICATIONS

The present disclosure is a continuation of U.S. application Ser. No. 17/950,269, filed on Sep. 22, 2022, which is incorporated in its entirety herein by reference.

### FIELD

This invention is relevant to the technical field of automotive parts, especially a solar car cover for a pickup truck.

### BACKGROUND

Pickup trucks, as a common type of vehicle, offer car-like comfort without losing power. Due to its strong cargo capacity and ability to poor road conditions and its strong overall performance makes it one of the most common off-roading vehicles. To enable the pickup truck to adapt to a wider range of environments, most existing pickup trucks require a truck bed cover, which is made up of multiple panels. Some of these panels are designed as solar panels to provide electrical power for the truck.

During the process of folding and unfolding the pickup truck car cover, the inventor identified at least the following problems in the prior art: poor support and fixation of the solar panels, which causes deformation of the solar panels during use, and the cumbersome operation of opening and closing the rear car cover.

### SUMMARY

The embodiments of the present invention a solar car cover for a pickup truck, which aims to at least solve the technical problem of poor support and fixation of the solar panels.

In order to solve the above problems of the existing technology, the technical solution adopted in the invention is as follows:

A solar car cover for a pickup truck, detachably mounted on the rear cargo hopper, is formed by splicing at least two panel frame assemblies. Each panel frame assembly consists of a panel and four frames surrounding the periphery of the panel. The four frames include two first frames arranged parallel to each other and two second frames arranged parallel to each other, with the first frames perpendicular to the second frames.

At least two first support rods are provided along the vertical direction relative to the first frames and are connected to the two first frames. The first support rods are either bonded to or abutted against the panel, and/or:

At least one second support rod is provided along the vertical direction relative to the second frames, with at least one end of the second support rod connected to the second frames, the second support rod is either bonded to or abutted against the panel.

A solar car cover for a pickup truck provided in the embodiments of this invention uses first and second support rods to cross-support and fix the solar panels in multiple directions and positions. This significantly enhances the support and fixation of the solar panels, thereby extending their service life.

Further, a rotating shaft is pivotally connected at the junction of two adjacent panel frame assemblies, allowing one of the panel frame assemblies to rotate relative to the other along the axis of the rotating shaft. This enables the two assemblies to switch between a horizontally flat state and a vertically folded state. This design enables the solar car cover to switch between a flat state and a folded state.

Further, the first support rod is arranged either between the second support rod and the panel or on the side of the second support rod that is away from the panel. The purpose of this design is to provide multi-directional and multi-positional comprehensive support for the panel, thereby preventing deformation of the panel.

Further, when the first support rod is arranged between the second support rod and the panel, a groove is provided at the intersection to accommodate the second support rod. The purpose of this design is to make a tighter connection between the first support rod and the second support rod, thereby enhancing their stability.

Further, the integrally formed extension plates on both sides of the second support rod abut against the surface of the first support rod facing the second support rod. This design aims to increase the contact area between the two through the extension plates, thereby making the connection more stable.

Further, when the first support rod is positioned on the side of the second support rod away from the panel, the side of the second support rod that close to the panel is in contact with the panel, the second support rod is arranged between the first support rod and the panel. This design aims to allow switching of the support position.

Further, both sides of each panel frame assembly are provided with a mating fastening structure, which connects to the rear cargo hopper through the mating fastening structure. The mating fastening structure comprises a support plate, a first slope is provided on the top surface of the support plate. A locking structure is provided on both the left and right sides of the second support rod. The locking structure comprises a locking unit and a dragging unit, wherein the locking unit comprises a reciprocating clamping block, the dragging unit comprises a traction rope. The traction rope pulls the clamping block to move toward or away from the support plate. This design aims to achieved the opening and closing actions of the rear car cover and the rear cargo hopper with a simple pull and push motion.

Further, the locking unit includes:
A first crossbar, with a sliding rail arranged inside it, the clamping block slides along the sliding rail, a spring is provided between the clamping block and the sliding rail;
A traction rod comprises a fixing part, a main part, and a connecting part. At least two fixing holes are provided along the vertical direction to the top surface of the fixing part, a channel is provided along the vertical direction to the side surface of the fixing part, the channel is in communication with the fixing holes.

Further, the clamping block comprises:
A sliding part is slidably connected within the sliding rail, a connecting hole is provided in the inner cavity of the sliding part, the connecting part is connected to the connecting hole;
A clamping part is provided with a second slope, the second slope is arranged nearly parallel to the first slope;
One end of the transition part is connected to the sliding part, while the other end is connected to the clamping part.

Further, the dragging unit comprises:
A second crossbar, with a bracket arranged inside, where the bracket contains at least two branch rods;
One side of the dragging strap is sleeved on the outside of the traction rope, while the other side is provided with a traction handle.

Further, the mating fastening structure further comprises a first clamp and a second clamp, the second clamp is fixed to the first clamp with a fastening bolt.

Further, the first support rod and the second support rod are bonded, abutted, or connected by fasteners.

### BRIEF DESCRIPTION OF THE DRAWINGS

FIG. 1 is the first perspective schematic view of the solar car cover according to the embodiment of the present invention.

FIG. 2 is the second perspective schematic view of the solar car cover according to the embodiment of the present invention.

FIG. 3 is the first perspective schematic view of the panel frame assembly according to the embodiment of the present invention.

FIG. 4 is the second perspective schematic view of the panel frame assembly according to the embodiment of the present invention.

FIG. 5 is the assembly diagram of the first and second support rods according to the embodiment of the present invention.

FIG. 6 is the schematic view of an alternative embodiment of the first support rod according to the present invention.

FIG. 7 is the first perspective schematic view of the locking structure according to the embodiment of the present invention.

FIG. 8 is the second perspective schematic view of the locking structure according to the embodiment of the present invention.

FIG. 9 is the assembly diagram of the clamping block and supporting plate according to the embodiment of the present invention.

FIG. 10 is the schematic view of the clamping block according to the embodiment of the present invention.

FIG. 11 is the schematic view of the traction rod according to the embodiment of the present invention.

FIG. 12 is the schematic view of the mating fastening structure according to the embodiment of the present invention.

### FIGURES

1. Panel Frame Assembly 11. Panel, 12. First Frame 13. Second Frame 14. First Support Rod 141. Groove 15. Second Support Rod 151. Extension Plate 16. Locking Structure 161. First Crossbar 162. Second Crossbar 163. Sliding Rail 164. Clamping Block 1641. Sliding Part 16411. Connecting Hole 1642. Transition Part 1643. Clamping Part 1644. Second Slope 165. Traction Rod 1651. Fixing Part 1652. Main Part 1653. Connecting Part 1654. Channel, 1655. Fixing Hole 166. Spring 167. Traction Rope
2. Mating Fastening Structure 21. Support plate 211. First Slope 22. First Clamp 23. Second Clamp
3. Rotating Shaft

### DETAILED DESCRIPTION OF THE DISCLOSURE

The following instruction further explains the invention's concrete implementation method.

In the description in this invention, it is to be understood that the orientation or positional relationships indicated by the terms “top”, “bottom”, “inside”, “outside”, “top”, “bottom”, “top”, “bottom”, “inside”, “bottom”, “inside”, “outside”, etc. are based on the orientation or positional relationships shown in the accompanying drawings, which serve only to facilitate the explanation of the present invention and to simplify the description, rather than to indicate or imply that the described devices or components must have a specific orientation or be constructed and operated in a specific manner. Therefore, it should not be construed as a limitation of the present invention.

In the description of the invention, it should also be noted that, unless otherwise expressly specified and defined, the terms “arranged,” “installed,” “connected,” and “combined” should be understood in a broad sense. For example, it can refer to either a fixed connection, a detachable connection, or an integrated connection; it can be mechanical connections, electrical connections, direct connections, or indirect connections through intermediate media, as well as communication within two components. For a person skilled in the art, the specific meaning of these terms in the context of the present invention can be understood according to the specific circumstances.

In this invention, unless otherwise stated, directional terms such as “axial,” “circumferential,” and “radial” generally refer to directions defined relative to the rotational axis of the rotor in the drive motor. “Inner” and “outer” refer to the inside and outside of the respective component profiles. The use of terms such as “first,” “second,” etc., is intended to distinguish between different components and does not imply any sequential or hierarchical importance. Furthermore, in the following description, when referring to the drawings, the same reference numerals in different drawings indicate the same or similar elements, unless otherwise explained.

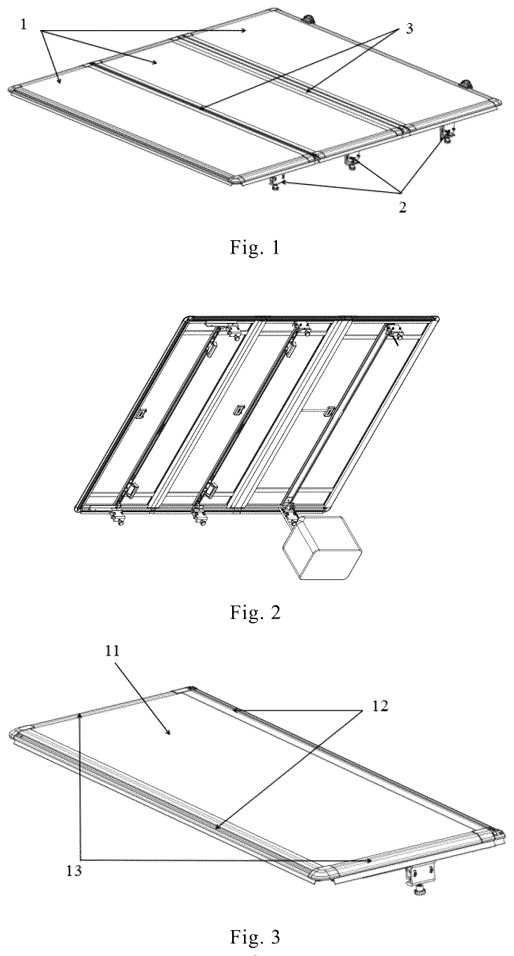

The embodiment of the present invention discloses a solar car cover for a pickup truck, detachably mounted on the rear cargo hopper, as shown in FIGS. 1, 2, 3, and 4; the solar car cover is formed by splicing at least two panel frame assemblies 1. Each panel frame assembly 1 consists of a panel 11 and four frames surrounding the periphery of the panel 11. The four frames include two first frames 12 arranged parallel to each other and two second frames 13 arranged parallel to each other, with the first frames 12 perpendicular to the second frames 13.

It should be noted that the panel 11 is a solar panel, and the backside of the solar panel is provided with a power plug-in. In addition, the connections between the solar panels and the power connector circuits can be either circuit in parallel or series. The aforementioned series or parallel circuits may increase or may not increase the original power.

At least one first support rod 14 is provided along the vertical direction relative to the first frames 12 and is connected to the two first frames 12, the first support rod 14 is either bonded to or abutted against the panel 11, and/or:

At least one second support rod 15 is provided along the vertical direction relative to the second frames 13, with at least one end of the second support rod 15 connected to the second frames 13, the second support rod 15 is either bonded to or abutted against the panel 11.

The embodiment of the invention provides a solar car cover for a pickup truck, which uses the first and second support rods to cross-support and fix the solar panels in multiple directions and positions. This significantly enhances the support and fixation of the solar panels, thereby extending their service life.

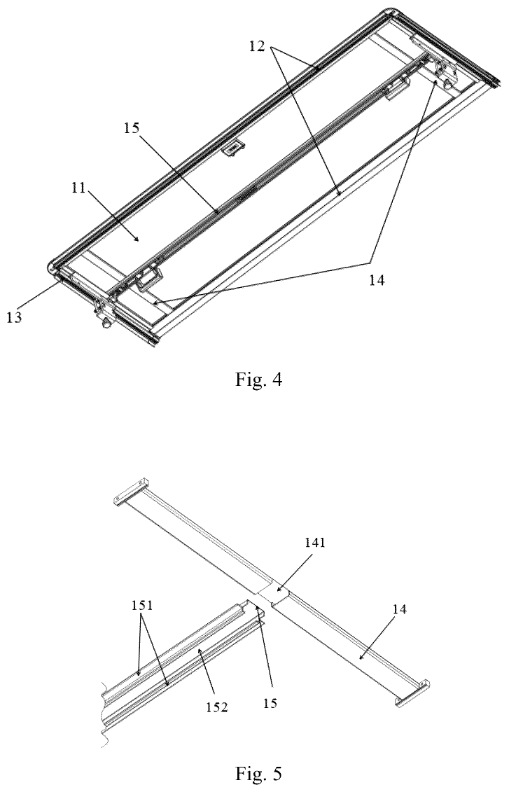

As shown in FIG. 4, the first support rod 14 and the second support rod 15 are bonded, abutted, or connected by fasteners.

As shown in FIG. 1, a rotating shaft 3 that pivotally connected at the junction of two adjacent panel frame assemblies 1, allowing one of the panel frame assemblies 1 to rotate relative to the adjacent panel frame assembly 1 around the axis of the rotating shaft 3. This enables the two panel frame assemblies 1 to be in either a horizontally flat state or a vertically folded state. This design enables the solar car cover to switch between a flat state and a folded state.

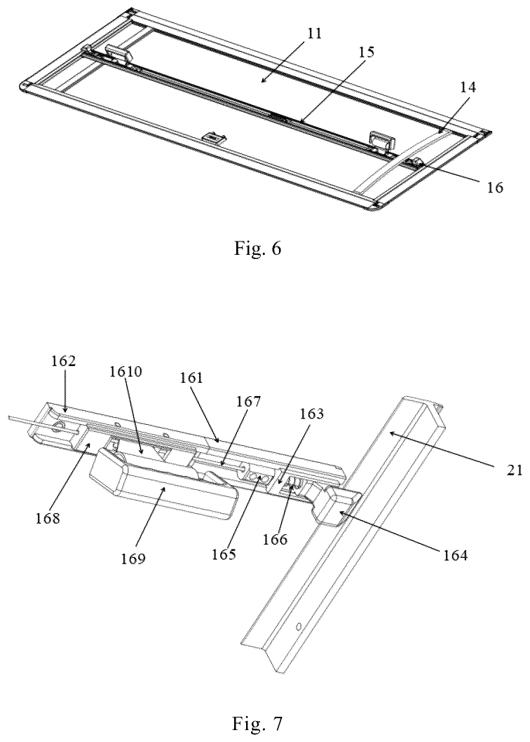

As shown in FIGS. 4 and 6, the first support rod 14 is arranged either between the second support rod 15 and the panel 11 or on the side of the second support rod 15 that is away from the panel 11 providing multi-directional and multi-positional comprehensive support for the panel, thereby prevent it from deforming.

As shown in FIG. 5, when the first support rod 14 is arranged between the second support rod 15 and the panel 11, a groove 141 is provided at the intersection of the first support rod 14 and the second support rod 15 to accommodate the second support rod 15, which makes a tighter connection between the first support rod and the second support rod, thereby enhancing their stability.

As shown in FIG. 5, the integrally formed extension plates 151 on both sides of the second support rod 15 abut against the surface of the first support rod 14 facing the second support rod 15. The design of the extension plates 151 increases the contact area between the two through the extension plates, thereby making the connection more stable.

As shown in FIG. 6, when the first support rod 14 is positioned on the side of the second support rod 15 away from the panel 11, the side of the second support rod 15 that close to the panel 1 is in contact with the panel 11, the second support rod 15 is arranged between the first support rod 14 and the panel 11. This design allows switching of the support position.

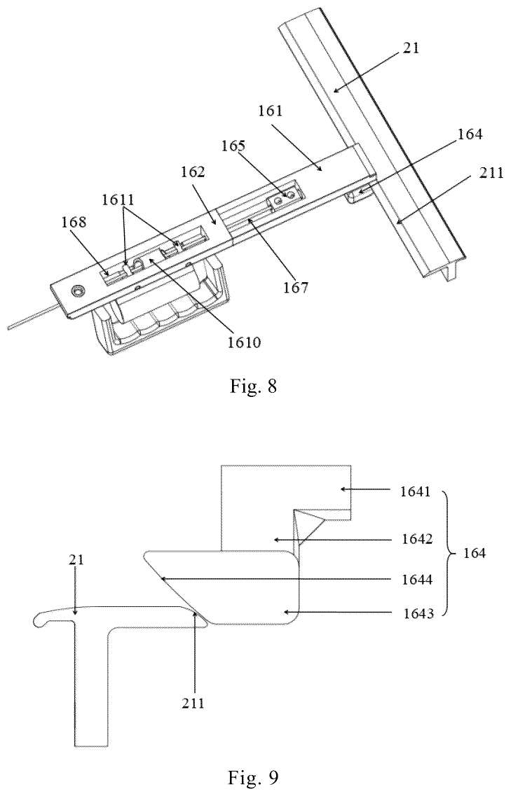

As shown in FIGS. 7 and 8, both sides of each panel frame assembly 1 are provided with a mating fastening structure 1, which connects to the rear cargo hopper through the mating fastening structure 2. The mating fastening structure 2 comprises a support plate 21, a first slope 211 is provided on the top surface of the support plate 21. A locking structure 16 is provided on both the left and right sides of the second support rod 15. The locking structure 16 comprises a locking unit and a dragging unit, wherein the locking unit comprises a reciprocating clamping block, and the dragging unit comprises a traction rope 167. The traction rope 167 pulls the clamping block 164 to move toward or away from the support plate 21. The pulling and pushing action facilitates the opening and closing of the rear car cover and the rear cargo hopper.

As shown in FIGS. 7 and 8, the specific embodiment of the locking units mentioned above is described below. the locking unit comprises a first crossbar 161 and a traction rod 165.

A sliding rail 163 is provided within the first crossbar 161, the clamping block 164 slides along the sliding rail 163, a spring 166 is provided between the clamping block 164 and the sliding rail 163;

A traction rod 165 comprises a fixing part 1651, a main part 1652, and a connecting part 1653. At least two fixing holes 1655 are provided along the vertical direction to the top surface of the fixing part 1651, and a channel 1654 is provided along the vertical direction to the side surface of the fixing part 1651, the channel 1654 is in communication with the fixing holes 1655.

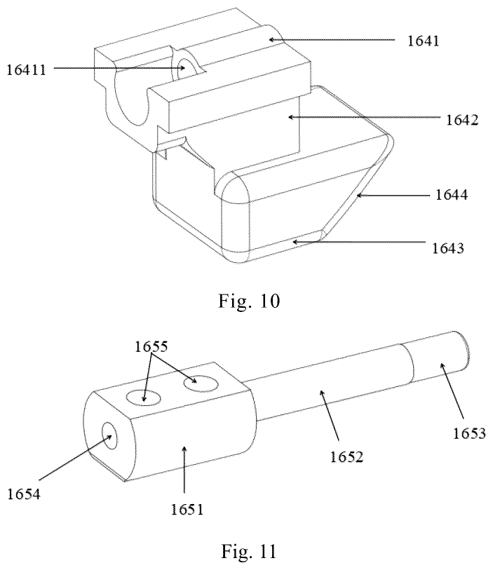

As shown in FIG. 10, the specific embodiment of the clamping block 164 mentioned above is described below. A clamping block 164 comprises a sliding part 1641, a clamping part 1643 and a transition part 1642. The sliding part 1641 is slidably connected within the sliding rail 163, a connecting hole 16411 is provided in the inner cavity of the sliding part 1641, the connecting part 1653 is connected to the connecting hole 16411. A clamping part 1643 is provided with a second slope 1644, the second slope 1644 is arranged nearly parallel to the first slope 211. One end of the transition part 1642 is connected to the sliding part 1641, while the other end is connected to the clamping part.

When the rear car cover is closed onto the rear cargo hopper, the cover is in a flat position. As the cover is pressed downward, the first slope 211 of the clamping block 164 comes into contact with the second slope 1644. The clamping block 164 moves along the sliding rail 163 in the direction away from the support plate 21, and compresses the spring 166. The spring deforms elastically under compression when compressed. When the clamping part 1643 of the clamping block 164 is positioned under the support plate 21, the clamping part 1643 of the clamping block 164 clamped with the support plate 21 under the elastic reaction force of the spring 166, securely locking the rear car cover to the pickup truck cargo hopper, thereby closing the car cover.

When the rear car cover is opened, the traction handle 169 is pulled in the direction away from the second crossbar 162, the traction handle 169 pulls the traction rope 167 through the strap 1610, the traction rope 167 drives the clamping block 164 to separate from the support plate 21 through the traction rod 165, folds the rear car cover to enable opening the pickup truck rear cargo hopper.

As shown in FIGS. 7 and 8, the specific embodiment of the dragging unit mentioned above is described below. The dragging unit comprises a second crossbar 162 and a dragging strap 1610. A bracket 168 is arranged inside the second crossbar 162, where the bracket 168 contains at least two branch rods 1611. One side of the dragging strap 1610 is sleeved on the outside of the traction rope 167, while the other side is provided with a traction handle 169.

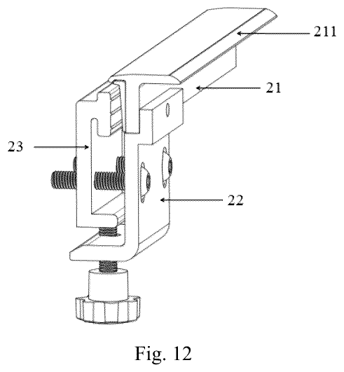

As shown in FIG. 12, the specific embodiment of the mating fastening structure 2 mentioned above is described below. The mating fastening structure 2 further comprises a first clamp 22 and a second clamp 23, the second clamp 23 is fixed to the first clamp 22 with a fastening bolt.

In the description of this specification, specific features, structures, materials, or characteristics may be combined in any one or more embodiments or examples in a suitable manner.

The invention is not limited to the above-mentioned optional embodiments. Anyone can come up with various other forms of products under the inspiration of the invention, however, regardless of any changes in its shape or structure. All technical solutions that fall within the scope defined by the claims of the present invention shall fall within the scope of protection of the invention.

What is claimed is:

1. A solar car cover for a pickup truck, detachably mounted on the rear cargo hopper, formed by splicing at least two panel frame assemblies, wherein each panel frame assembly consists of a panel and four frames surrounding the periphery of the panel, the four frames include two first frames arranged parallel to each other and two second frames arranged parallel to each other, with the first frames being perpendicular to the second frames, wherein
at least one first support rod is provided along the vertical direction relative to the first frames and is connected to the two first frames, the first support rod is either bonded to or abutted against the panel;
and/or
at least one second support rod is provided along the vertical direction relative to the second frames, with at least one end of the second support rod connected to the second frames, the second support rod is either bonded to or abutted against the panel.

2. The solar car cover for a pickup truck according to claim 1, wherein a rotating shaft is pivotally connected at the junction of two adjacent panel frame assemblies, allowing one of the panel frame assemblies to rotate relative to the adjacent panel frame assembly around the axis of the rotating shaft, this enables the two panel frame assemblies to be in either a horizontally flat state or a vertically folded state.

3. The solar car cover for a pickup truck according to claim 1, wherein the first support rod is arranged either between the second support rod and the panel or on the side of the second support rod that is away from the panel.

4. The solar car cover for a pickup truck according to claim 3, wherein when the first support rod is arranged between the second support rod and the panel, a groove is provided at the intersection of the first support rod and the second support rod to accommodate the second support rod.

5. The solar car cover for a pickup truck according to claim 4, wherein the integrally formed extension plates on both sides of the second support rod abut against the surface of the first support rod facing the second support rod.

6. The solar car cover for a pickup truck according to claim 3, wherein when the first support rod is positioned on the side of the second support rod away from the panel, the side of the second support rod that close to the panel is in contact with the panel, the second support rod is arranged between the first support rod and the panel.

7. The solar car cover for a pickup truck according to claim 4, wherein:
both sides of each panel frame assembly are provided with a mating fastening structure, which connects to the rear cargo hopper through the mating fastening structure, the mating fastening structure comprises a support plate, a first slope is provided on the top surface of the support plate;
a locking structure is provided on both sides of the second support rod, the locking structure comprises a locking unit and a dragging unit, wherein the locking unit comprises a reciprocating clamping block, the dragging unit comprises a traction rope, the traction rope pulls the clamping block to move towards or away from the support plate.

8. The solar car cover for a pickup truck according to claim 7, wherein the locking unit comprises:
a first crossbar, with a sliding rail arranged inside it, the clamping block slides along the sliding rail, a spring is provided between the clamping block and the sliding rail;
a traction rod comprises a fixing part, a main part, and a connecting part, at least two fixing holes are provided along the vertical direction to the top surface of the fixing part, a channel is provided along the vertical direction to the side surface of the fixing part, the channel is in communication with the fixing holes.

9. The solar car cover for a pickup truck according to claim 8, wherein the clamping block comprises:
a sliding part is slidably connected within the sliding rail, a connecting hole is provided in the inner cavity of the sliding part, the connecting part is connected to the connecting hole;
a clamping part is provided with a second slope, the second slope is arranged nearly parallel to the first slope;
one end of the transition part is connected to the sliding part, while the other end connected to the clamping part.

10. The solar car cover for a pickup truck according to claim 7, wherein the dragging unit comprises:
a second crossbar, with a bracket arranged inside, where the bracket contains at least two branch rods;
one side of the dragging strap is sleeved on the outside of the traction rope, while the other side is provided with a traction handle.

11. The solar car cover for a pickup truck according to claim 7, wherein the mating fastening structure further comprises a first clamp and a second clamp, the second clamp is fixed to the first clamp by a fastening bolt.

12. The solar car cover for a pickup truck according to claim 1, wherein the first support rod and the second support rod are bonded, abutted, or connected by fasteners.
